(19) United States
(12) Patent Application Publication
(10) Pub. No.: US 2014/0297115 A1
(43) Pub. Date: Oct. 2, 2014

(54) SYSTEM AND METHOD FOR CONTROLLING VEHICLE DRIVING MODE

(71) Applicants: Kia Motors Corporation, Seoul (KR); Hyundai Motor Company, Seoul (KR)

(72) Inventors: Sheen Gil KANG, Suwon-si (KR); Ki Mo SOHN, Seoul (KR); Seung Han YOU, Seoul (KR); Ho Wook LEE, Seoul (KR); Young Ho SHIN, Seoul (KR); Won Sub CHOI, Cheongju (KR)

(21) Appl. No.: 13/938,878

(22) Filed: Jul. 10, 2013

(30) Foreign Application Priority Data
Apr. 1, 2013 (KR) 10-2013-0035059

(51) Int. Cl. G06F 7/00

(52) U.S. Cl. CPC G06F 7/00
USPC 701/37; 701/1; 701/41

(57) ABSTRACT

A method for controlling a vehicle driving mode includes establishing a driving mode on the basis of a driver driving mode entered by user selection, receiving vehicle state measurement values from a plurality of vehicle sensors, comparing the received vehicle state measurement value with an emergency avoidance mode condition and a rough-road driving mode condition if the vehicle state measurement value is identical to the emergency avoidance mode condition or the rough-road driving mode condition according to the result of comparison, changing a predetermined driver driving mode to a driving mode matched with the corresponding condition, and controlling operations of a vehicle controller on the basis of vehicle device control information matched with the changed driving mode.

### CROSS-REFERENCE TO RELATED APPLICATION

This application claims the benefit of priority to Korean patent application No. 10-2013-0035059 filed on Apr. 1, 2013, the disclosure of which is hereby incorporated in its entirety by reference.

### BACKGROUND

The present disclosure relate to a system and method for controlling a vehicle driving mode.

A vehicle driving mode applied to general vehicles can allocate the same mode to individual systems according to a mode selected by a vehicle driver who uses an input device.

In this case, the vehicle driving mode for the vehicle to drive according to a driver-selected driving mode even when the vehicle needs to suddenly move due to the occurrence of an emergency situation such as a collision avoidance situation, so that the vehicle driver experiences discomfort in steering or feels deterioration of ride-comfort caused by impact from a road.

### SUMMARY

Various embodiments of the present inventive concept are directed to providing a system and method for controlling a vehicle driving mode that substantially obviates one or more problems due to limitations and disadvantages of the related art.

An embodiment of the present invention relates to a system and method for controlling a vehicle driving mode which can automatically control a driving mode when an emergency avoidance situation or a rough-road running situation occurs during vehicle driving.

In accordance with one embodiment of the present invention, a system for controlling a vehicle driving mode includes: a driver mode input for transmitting a driver driving mode entered by user selection to a driving-mode integrated controller; a driving mode integrated controller for establishing a driving mode in response to the driver driving mode received from the driver mode input, comparing a vehicle state measurement value received from a plurality of vehicle sensors with each of an emergency avoidance mode condition and a rough-road driving mode condition, changing, if the vehicle state measurement value is identical to the emergency avoidance mode condition or the rough-road driving mode condition, a predetermined driver driving mode to a driving mode matched with the corresponding condition, and outputting vehicle device control information matched with the corresponding driving mode; and a vehicle controller operated on the basis of the vehicle device control information received from the driving-mode integrated controller.

The driving mode integrated controller may include: a driving mode determiner for comparing a vehicle state measurement value received from a radar sensor or a vision sensor with the emergency avoidance mode condition, comparing a vehicle state measurement value received from a wheel-speed sensor and an acceleration sensor with the rough-road driving mode condition, and thus recognizing a driving mode matched with the result of comparison.

If the vehicle state measurement values received from the vehicle sensors are identical to the emergency avoidance mode condition and the rough-road driving mode condition, the driving mode determiner may select a driving mode according to predetermined priority information.

The driving mode integrated controller may further include: a driving mode control processor for transmitting control information to the corresponding vehicle controller according to a driving mode selected by the driving mode determiner from among the emergency avoidance mode, the rough-road driving mode, and the driver driving mode.

The vehicle controller may be at least one of Motor Driven Power Steering (MDPS), Electronic Control Suspension (ECS), Electronic Stability Control (ESC), and 4 Wheel Drive (4WD).

In accordance with another embodiment of the present inventive concept, a method for controlling a vehicle driving mode includes: establishing a driving mode on the basis of a driver driving mode entered by user selection; receiving vehicle state measurement values from a plurality of vehicle sensors; comparing the received vehicle state measurement value with an emergency avoidance mode condition and a rough-road driving mode condition; if the vehicle state measurement value is identical to the emergency avoidance mode condition or the rough-road driving mode condition according to the result of comparison, changing a predetermined driver driving mode to a driving mode matched with the corresponding condition; and controlling operations of a vehicle controller on the basis of vehicle device control information matched with the changed driving mode. Comparing the received vehicle state measurement value with the emergency avoidance mode condition and the rough-road driving mode condition may include: a vehicle state measurement value received from a radar sensor or a vision sensor with the emergency avoidance mode condition; and a vehicle state measurement value received from a wheel-speed sensor or an acceleration sensor with the rough-road driving mode condition.

Receiving the vehicle state measurement value may include the vehicle state measurement value from at least one vehicle sensor from among a radar sensor, a vision sensor, a wheel-speed sensor, and an acceleration sensor.

Detailed characteristics and advantages of the present disclosure will be more clearly understood by reading the following description with reference to the accompanying drawings.

Prior to description, the terms or words used in the disclosure and the claims are not interpreted as having general meanings or dictionary meanings, but should be interpreted as having meanings and concepts coinciding with the technical scope and sprit of the present inventive concept based on the principle in that an inventor may properly define the concept of terms to describe the present inventive concept in the best mode.

### BRIEF DESCRIPTION OF THE DRAWINGS

FIG. 1 is a block diagram illustrating a system for controlling a vehicle driving mode according to an embodiment of the present inventive concept.

FIG. 2 is a detailed block diagram illustrating an integrated controller for a vehicle driving mode according to an embodiment of the present inventive concept.

FIG. 3 is a flowchart illustrating a method for controlling a vehicle driving mode according to an embodiment of the present inventive concept.

FIG. 4 is a conceptual diagram illustrating a method for controlling a vehicle driving mode according to an embodiment of the present inventive concept.

### DESCRIPTION OF EMBODIMENTS

Hereinafter, the above and other objects, specific advantages, and novel features of the present disclosure will become apparent from the following description of embodiments, given in conjunction with the accompanying drawings. Reference will now be made in detail to the embodiments of the present inventive concept, examples of which are illustrated in the accompanying drawings. Wherever possible, the same reference numbers will be used throughout the drawings to refer to the same or like parts. In the following description, known functions or structures, which may confuse the substance of the present disclosure, are not explained. It will be understood that, although the terms first, second, etc. may be used herein to describe various elements, components, regions, layers and/or sections, these elements, components, regions, layers and/or sections should not be limited by these terms.

A system and method for controlling a vehicle driving mode according to embodiments of the present inventive concept will hereinafter be described with reference to the attached drawings.

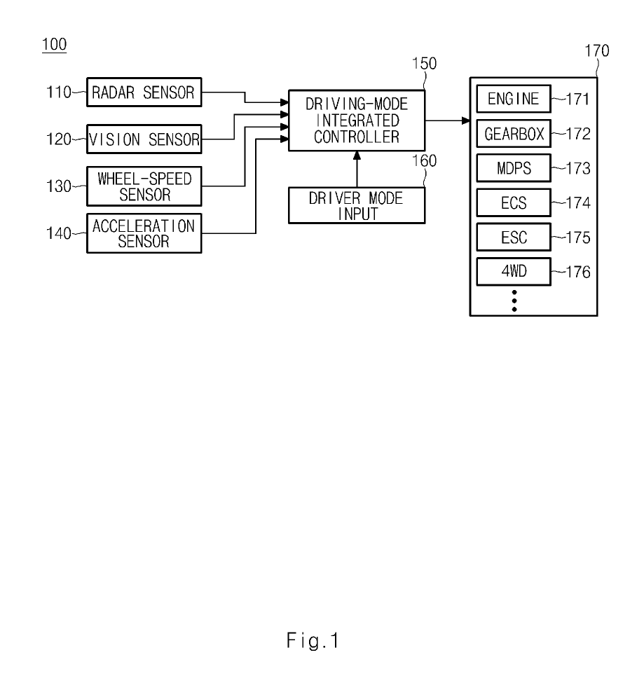

FIG. 1 is a block diagram illustrating a system for controlling a vehicle driving mode according to an embodiment of the present inventive concept.

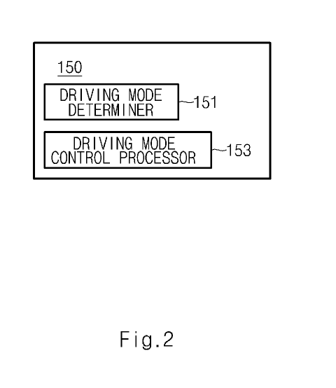

FIG. 2 is a detailed block diagram illustrating an integrated controller for the vehicle driving mode according to an embodiment of the present inventive concept.

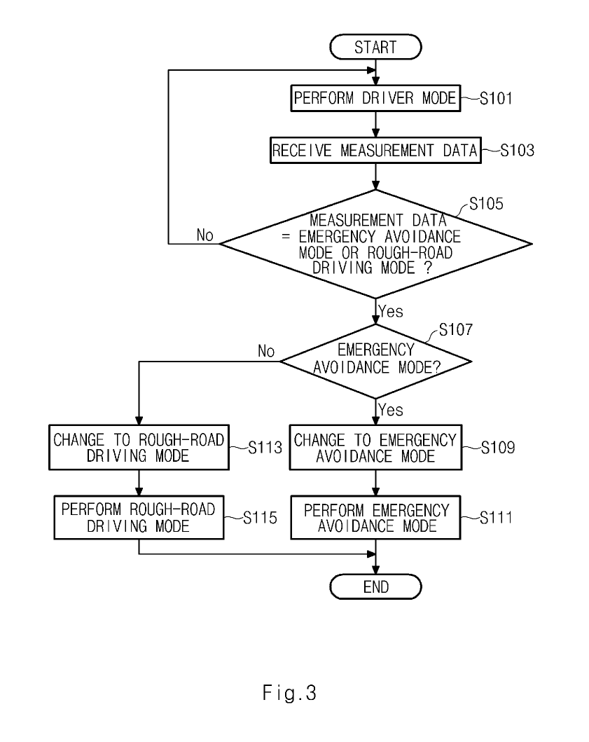

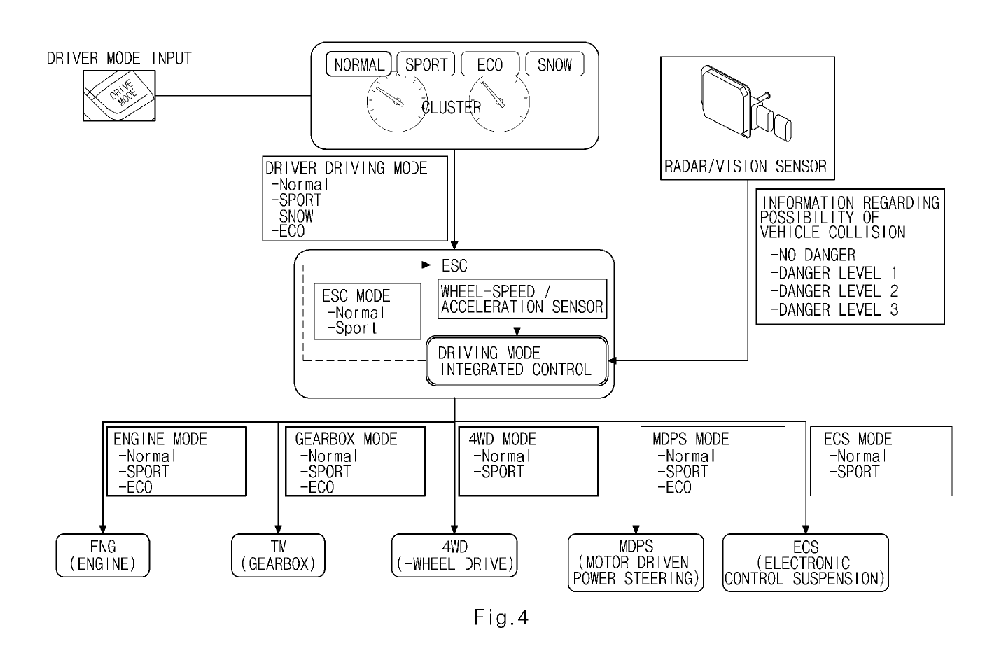

FIG. 3 is a flowchart illustrating a method for controlling a vehicle driving mode according to an embodiment of the present inventive concept. FIG. 4 is a conceptual diagram illustrating a method for controlling a vehicle driving mode according to an embodiment of the present inventive concept. Referring to FIG. 1, a controller 100 for controlling a vehicle driving mode (hereinafter referred to as a vehicle mode control system) includes a vehicle sensor, a driving mode integrated controller 150, a driver mode input 160, and a vehicle controller 170.

In more detail, the driver mode input 160 may transmit a driver driving mode entered by user selection to the driving mode integrated controller 150.

For example, as shown in FIG. 4, a driver may enter any one of a normal mode (NORMAL), a sport mode (SPORT), an eco mode (ECO), and a snow mode (SNOW) through a separate switch (not shown).

In this case, the normal mode may be established as a default mode when a user does not select a desired driver mode when selection of the driver mode other than the normal mode is released.

As seen from FIG. 4, the driver driving mode established by a vehicle driver may be displayed on a cluster mounted to the vehicle.

The driving mode integrated controller 150 establishes a driving mode in response to a driver driving mode received from the driver mode input 160, and compares each vehicle state measurement value received from a plurality of vehicle sensors with an emergency avoidance mode condition or a rough-road driving mode condition. If the vehicle state measurement value is identical to the emergency avoidance mode condition or the rough-road driving mode condition, the driving mode integrated controller 150 changes a predetermined driver driving mode to a driving mode appropriate for the condition to output vehicle device control information matched with the corresponding driving mode.

In this case, the vehicle sensor may be at least one of a radar sensor 110, a vision sensor 120, a wheel-speed sensor 130, and an acceleration sensor 140, and the scope or spirit of the vehicle sensor is not limited thereto.

On the other hand, as shown in FIG. 2, the driving mode integrated controller 150 may include a driving mode determiner 151 and a driving mode control processor 153.

The driving mode determiner 151 compares a vehicle state measurement value received from the radar sensor or the vision sensor 120 with the emergency avoidance mode condition, compares a vehicle state measurement value received from the wheel-speed sensor 130 or the acceleration sensor 140 with the rough-road driving mode condition, and thus recognizes an appropriate driving mode according to the comparison results.

In addition, if the vehicle state measurement values received from the vehicle sensors are identical to the emergency avoidance mode condition and the rough-road mode condition, the driving mode determiner 151 may select an appropriate driving mode according to predetermined priority.

That is, the driving mode determiner 151 first executes the emergency avoidance mode and the rough-road driving mode rather than the driver driving mode, and priority of the emergency avoidance mode and priority of the rough-road driving mode may be established and changed according to user convenience.

In addition, the driving mode control processor 153 may transmit control information to the corresponding vehicle controller 170 according to the driving mode selected by the driving mode determiner 151 from among the emergency avoidance mode, the rough-road driving mode, and the driver driving mode.

The driving mode determiner 151 receives information regarding the possibility of vehicle collision capable of being measured by the radar sensor 110 or the vision sensor 120, and determines whether or not the emergency avoidance mode begins on the basis of the received information. If an Electronic Stability Control (ESC) operation is available, the driving mode control processor 153 outputs vehicle device control information for lightening Motor Driven Power Steering (MDPS), hardening Electronic Control Suspension (ECS), and achieving not only early intervention in Electronic Stability Control (ESC) but also quick engine response.

In addition, the driving mode determiner 151 determines whether or not the vehicle is running on a rough road on the basis of vehicle state measurement values received from the wheel-speed sensor 130 or the acceleration sensor 140. The driving mode determiner 151 commands the driving mode control processor 153 to output vehicle device control information in such a manner that MDPS is insensitive to road-surface reaction, ECS is softened, ESC early begins, and an engine becomes normal. In other words, as can be seen from FIG. 4, although the driving mode driving mode controller 100 establishes an initial driving mode on the basis of the driver driving mode, it determines whether the emergency avoidance situation or the rough-road driving situation occurs on the basis of vehicle state measurement values obtained from the vehicle sensors such as the radar sensor, and thus transmits appropriate control information to the corresponding vehicle controller 170.

The control target and control degree of the vehicle controller according to the emergency avoidance mode and or the rough-road driving mode may be changed according to the necessity of a user or an operator.

The vehicle controller 170 may be controlled on the basis of vehicle device control information received from the driving mode integrated controller 150. In this case, the vehicle controller 170 may be at least one of MDPS, ECS, ESC, and 4 Wheel Drive (4WD), and the scope or spirit of the present disclosure is not limited thereto.

FIG. 3 is a flowchart illustrating a method for controlling a vehicle driving mode according to an embodiment of the present inventive concept.

Referring to FIG. 3, the driving mode driving mode controller may establish a driving mode on the basis of a driver driving mode entered by user selection at step S101.

The driving mode driving mode controller 100 may receive vehicle state measurement values from a plurality of vehicle sensors at step S103.

In this case, the vehicle sensor may be at least one of a radar sensor 110, a vision sensor 120, a wheel-speed sensor 130, and an acceleration sensor 140, and the scope or spirit of the present disclosure is not limited thereto. Thereafter, the driving mode driving mode controller 100 may compare the received vehicle state measurement value with the emergency avoidance mode and the rough-road driving mode in step S105.

The step S105 may include comparing a vehicle state measurement value received from the radar sensor 110 or the vision sensor 120 with a condition of the emergency avoidance mode; and comparing a vehicle state measurement value received from the wheel-speed sensor 130 or the acceleration sensor 140 with a condition of the rough-road driving mode.

If the vehicle state measurement value is identical to the emergency avoidance mode condition or the rough-road driving mode condition in step S105, the driving mode driving mode controller may change a predetermined driver driving mode to a driving mode appropriate for the condition.

In more detail, if the vehicle state measurement value is identical to the emergency avoidance mode condition from among the emergency avoidance mode condition and the rough-road driving mode condition in step S107, the driving mode driving mode controller 100 may change the predetermined driver driving mode to the emergency avoidance mode in step S109.

If the vehicle state measurement value is identical to the rough-road driving mode condition, the driving mode driving mode controller 100 may change the driver driving mode to the rough-road driving mode in step S113.

If the vehicle state measurement value is different from the emergency avoidance mode condition or the rough-road driving mode condition in step S105, the driving mode driving mode controller 100 may restart from step S101.

The vehicle mode control system 100 may control the operation of the vehicle controller 170 on the basis of vehicle device control information matched with the changed driving mode.

In more detail, if the vehicle state measurement value is identical to the emergency avoidance mode condition, the driving mode driving mode controller 100 transmits vehicle device control information matched with the emergency avoidance mode condition to the corresponding vehicle controller 170, and thus performs the emergency avoidance mode in step S111.

In addition, if the vehicle state measurement value is identical to the rough-road driving mode condition, the driving mode driving mode controller 100 transmits vehicle device control information matched with the rough-road driving mode condition to the corresponding vehicle controller 170, and thus performs the rough-road driving mode in step S115.

In this case, the vehicle controller 170 may be at least one of an engine, a gearbox, MDPS, ECS, ESC, and 4WD, and the scope or spirit of the present disclosure is not limited thereto.

The above-mentioned driving mode control method according to embodiments of the present inventive concept may be realized in the form of program commands that are executable by various computing means, processors, and written in computer readable media. The computer readable media may include program commands, data files, and data structures alone or in a combined state.

The program commands recoded in the media may be particularly designed and configured for the present disclosure or well known to those skilled in the art related to computer software.

Examples of the computer readable media may include magnetic media, such as a hard disk, a floppy disk, and a magnetic tape, optical media, such as a compact disc read only memory (CD-ROM) and a digital versatile disc (DVD), magneto-optical media, such as a floptical disk, and hardware devices, such as a read only memory (ROM), a random access memory (RAM), and a flash memory, which are particularly configured to store and execute program commands. Meanwhile, the recording medium may be set to a transmission medium, such as an optical or metal line, a waveguide, etc. including a carrier carrying a signal indicating a program command and a data structure.

Examples of the program commands may include high-level language codes executable by a computer using an interpreter as well as machine language codes generated by a complier. The hardware devices may be configured to function as one or more software modules to perform the operation an embodiment of the present inventive concept, or vice versa.

It will be apparent to those skilled in the art that various modifications and variations can be made in the present disclosure without departing from the spirit or scope of the inventions. Thus, the present disclosure covers the modifications and variations provided within the scope of the appended claims and their equivalents.

As is apparent from the above description, the system and method for controlling a vehicle driving mode according to embodiments of the present inventive concept determines whether an emergency avoidance situation or a rough-road running situation occurs using a vehicle state measurement value acquired from sensors mounted to a vehicle, and automatically changes a vehicle driving mode to another mode according to the result of determination, such that vehicle stability and safety and vehicle's emergency response capability can be improved, resulting in a guarantee of the safety of a vehicle driver.

In addition, the embodiments of the present inventive concept may reduce discomfort in steering controlled by a driver of the vehicle running on a rough road, and give a comfortable ride to the vehicle driver on the rough road.

Although the preferred embodiments of the present inventive concept have been disclosed for illustrative purposes, those skilled in the art will appreciate that various modifications, additions and substitutions are possible, without departing from the scope and spirit of the invention as disclosed in the accompanying claims.

1. A system for controlling a vehicle driving mode comprising:
a driver mode input for transmitting a driver driving mode entered by user selection to a single driving-mode integrated controller;
the single driving-mode integrated controller for establishing the vehicle driving mode in response to the driver driving mode received from the driver mode input, comparing vehicle state measurement values received from a plurality of vehicle sensors with each of an emergency avoidance mode condition and a rough-road driving mode condition, changing, if the vehicle state measurement values are identical to the emergency avoidance mode condition or the rough-road driving mode condition, the driver driving mode to the vehicle driving mode matched with a current condition, and outputting vehicle device control information matched with the vehicle driving mode; and
a vehicle controller operated using the vehicle device control information received from the single driving-mode integrated controller.

2. The system according to claim 1, wherein the single driving-mode integrated controller includes:
a driving mode determiner for comparing the vehicle state measurement values received from a radar sensor or a vision sensor with the emergency avoidance mode condition, comparing the vehicle state measurement values received from a wheel-speed sensor and an acceleration sensor with the rough-road driving mode condition, and thus recognizing the changed vehicle driving mode.

3. The system according to claim 2, wherein:
if the vehicle state measurement values received from the vehicle sensors are identical to the emergency avoidance mode condition and the rough-road driving mode condition, the driving mode determiner selects the vehicle driving mode according to predetermined priority information.

4. The system according to claim 2, wherein the single driving-mode integrated controller further includes:
a driving mode control processor for transmitting control information to the vehicle controller according to the vehicle driving mode selected by the driving mode determiner from among the emergency avoidance mode, the rough-road driving mode, and the driver driving mode.

5. The system according to claim 1, wherein the vehicle controller is at least one of Motor Driven Power Steering (MDPS), Electronic Control Suspension (ECS), Electronic Stability Control (ESC), and 4 Wheel Drive (4WD).

6. A method for controlling a vehicle driving mode comprising:
establishing the vehicle driving mode using a driver driving mode entered by user selection;
receiving vehicle state measurement values from a plurality of vehicle sensors;
comparing the received vehicle state measurement values with an emergency avoidance mode condition and a rough-road driving mode condition;
if the vehicle state measurement values are identical to the emergency avoidance mode condition or the rough-road driving mode condition, changing the vehicle driving mode matched with a current condition; and
controlling operations of a vehicle controller using vehicle device control information matched with the changed vehicle driving mode,
wherein all of the above steps are controlled by a single driving-mode integrated controller.

7. The method according to claim 6, wherein the comparing the received vehicle state measurement values with the emergency avoidance mode condition and the rough-road driving mode condition includes:
comparing the vehicle state measurement values received from a radar sensor or a vision sensor with the emergency avoidance mode condition; and
comparing the vehicle state measurement values received from a wheel-speed sensor or an acceleration sensor with the rough-road driving mode condition.

8. The method according to claim 6, wherein the receiving the vehicle state measurement value includes:
receiving the vehicle state measurement value from at least one vehicle sensor from among a radar sensor, a vision sensor, a wheel-speed sensor, and an acceleration sensor.

9. A non-transitory computer readable medium, the medium including indication commands for execution by a processor wherein the indication commands configure the processor to perform functions, including:
establishing a vehicle driving mode using a driver driving mode entered by user selection;
receiving vehicle state measurement values from a plurality of vehicle sensors;
comparing the received vehicle state measurement values with an emergency avoidance mode condition and a rough-road driving mode condition;
if the vehicle state measurement values are identical to the emergency avoidance mode condition or the rough-road driving mode condition, changing the vehicle driving mode matched with a current condition; and
controlling operations of a vehicle controller using vehicle device control information matched with the changed vehicle driving mode,
wherein all of the above steps are controlled by a single driving-mode integrated controller.

10. The system according to claim 1, wherein the driver driving mode is any one of a normal mode, a sport mode, an eco mode, and a snow mode.
